(19) United States
(12) Patent Application Publication
(10) Pub. No.: US 2008/0164773 A1
(43) Pub. Date: Jul. 10, 2008

(54) Stator for a Liquid Cooling Type Direct Drive Motor

(76) Inventor: CHIH-YU WANG, Taichung (TW)

Correspondence Address: Dr. BANGER SHIA, 102 Lindencrest Ct., Sugar Land, TX, 77479-5201, US

(21) Appl. No.: 11/620,650

(22) Filed: Jan. 6, 2007

(51) Int. Cl. H02K 1/20; H02K 9/19

(52) U.S. Cl. 310/54; 310/254

(57) ABSTRACT

A stator for a liquid cooling type direct drive motor comprises: annular base, silicon steel sheet, at least one metal cooling pipe, and coils. The stator is centrally provided with a rotor shaft with magnets. In the surface of the silicon steel sheet of the stator is formed a plurality of grooves, and the metal cooling pipe is continuously bent toward both sides and is positioned in the grooves of the silicon steel sheet and serves to enable coolant to circulate therein. Such arrangement simplifies the stator structure and can directly cool the silicon steel sheet, effectively and quickly lower the high temperature of the direct drive motor stator, and is compatible with the coolant passage system for an annular aluminum piece.

### BACKGROUND OF THE INVENTION

1. Field of the Invention

The present invention relates to a direct drive motor, and more particularly to a stator for a liquid cooling type direct drive motor, which can directly cool the silicon steel sheet, effectively and quickly lower the high temperature of the direct drive motor stator, and is compatible with the coolant passage system for a conventional annular aluminum piece.

2. Description of the Prior Art

Currently, motor devices are used more and more in industrial field, which generally include outer rotor and inner rotor types. In addition to the effect of high precision, the linear transmission device also has the advantages of low frictional loss, high energy conversion ratio, low noise and high rigidity. Hence, it is self-evident that the motor device is very important to various industrial mechanisms.

The existing direct drive motors are usually used in high precision and high load equipments, such as automatic equipment, indexing plate, and various machines. As shown in FIGS. 1 and 2, a conventional direct drive torque motor uses the coils 101 of the outer stator 10 to cooperate with the magnets 111 on the inner rotor 11. And from the outer side to the inner side of the outer stator 10 are orderly arranged an annular base 102, an annular aluminum piece 103, a silicon steel sheet 104 and coils 101. To improve the motors efficiency and to lower the high temperature caused adverse effect, it must install a cooling system on the outer stator 10, and the convention installation method is to make a helical water passage 1031 in the annular aluminum piece 103, and the annular base 102 is sealed by liquid and located outside the annular aluminum piece 103. In the annular base 102 are formed annular circulating holes 1021. The cooling water circulating in the annular circulating holes 1021 and the helical water passage 1031 cooperates with the annular aluminum piece 103 to achieve the cooling effect. This conventional design has the following disadvantages:

First, since the heat conduction of the cooling water should be transmitted to the annular aluminum piece 103 through the silicon steel sheet 104, heat transmission obstacle will occur between the assemblies.

Second, there is an interval between the annular aluminum piece 103 and the silicon steel sheet 104, and this will cause heat transmission obstacle.

Third, the conventional method is to make a helical water passage 1031 in the annular aluminum piece 103, and the annular base 102 is liquid-sealed outside the annular aluminum piece 103. In the annular base 102 are formed annular circulating holes 1021. This method is very material wasting and cost consuming, because it must add the annular aluminum piece 103 in order to form the helical water passage 1031 between the annular aluminum piece 103 and the annular base 102.

The present invention has arisen to mitigate and/or obviate the afore-described disadvantages.

### SUMMARY OF THE INVENTION

The primary objective of the present invention is to provide a stator for a liquid cooling type direct drive motor which can reduce the heat transmission obstacle while improving the stator for a direct drive motor.

The secondary objective of the present invention is to provide a simplified stator for a liquid cooling type direct drive motor.

Another objective of the present invention is to provide a stator for a liquid cooling type direct drive motor which is compatible with the cooling water passage system for the conventional annular aluminum piece.

To obtain the abovementioned objectives, the stator for a liquid cooling type direct drive motor in accordance with the present invention is centrally provided with a rotor shaft with magnets, and the stator is characterized in that:

The stator for a liquid cooling type direct drive motor in accordance with the present invention comprises: annular base, silicon steel sheet, at least one metal cooling pipe, and coils. In the surface of the silicon steel sheet of the stator is formed a plurality of grooves, and the metal cooling pipe is continuously bent toward both sides and is positioned in the grooves of the silicon steel sheet and serves to enable coolant to circulate therein.

With the design of the aforementioned metal cooling pipe, the present invention doesnøt need the annular aluminum piece anymore, therefore, the structure of the present invention is simplified.

In addition, the metal cooling pipe of the present invention is in direct contact with the silicon steel sheet and is received in the grooves of the silicon steel sheet. Therefore, the coolant within the metal cooling pipe can absorb the heat energy of the silicon steel sheet quickly and directly, effectively reducing the temperature of the stator for a liquid cooling type direct drive motor.

Finally, the metal cooling pipe is received in the grooves of the silicon steel sheet, thus it has no influence on the cooling passage system for the conventional annular aluminum piece. When there is a requirement of improving the cooling effect, the present invention can also be additionally provided (to be used) with the conventional annular aluminum piece and the water passage system.

### BRIEF DESCRIPTION OF THE DRAWINGS

FIG. 1 is a perspective view of a conventional stator for a liquid cooling type direct drive motor;

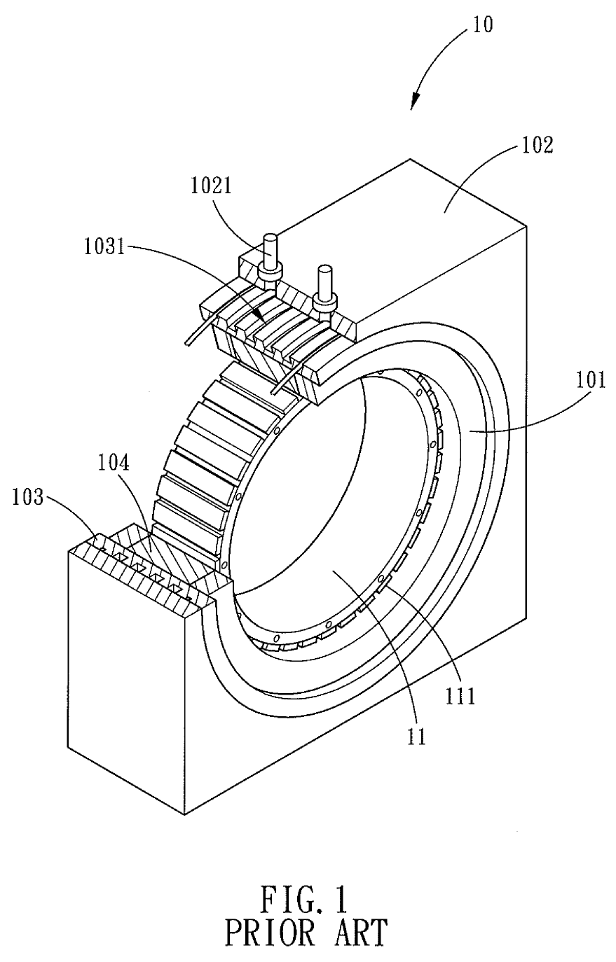

FIG. 2 is a cross sectional view of a part of the conventional stator;

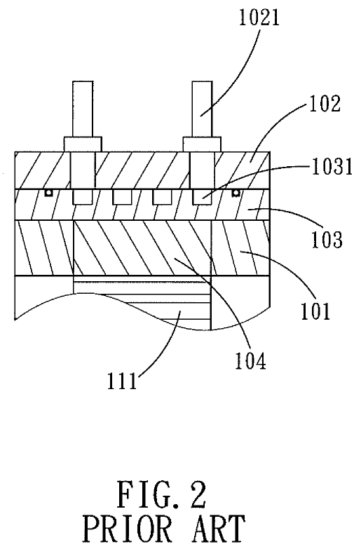

FIG. 3 is an exploded view of a metal cooling pipe and a silicon steel sheet in accordance with the present invention;

FIG. 4 is an assembly view of the metal cooling pipe and the silicon steel sheet in accordance with the present invention; and

FIG. 5 is a cross sectional view of a part of the embodiment of the present invention.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

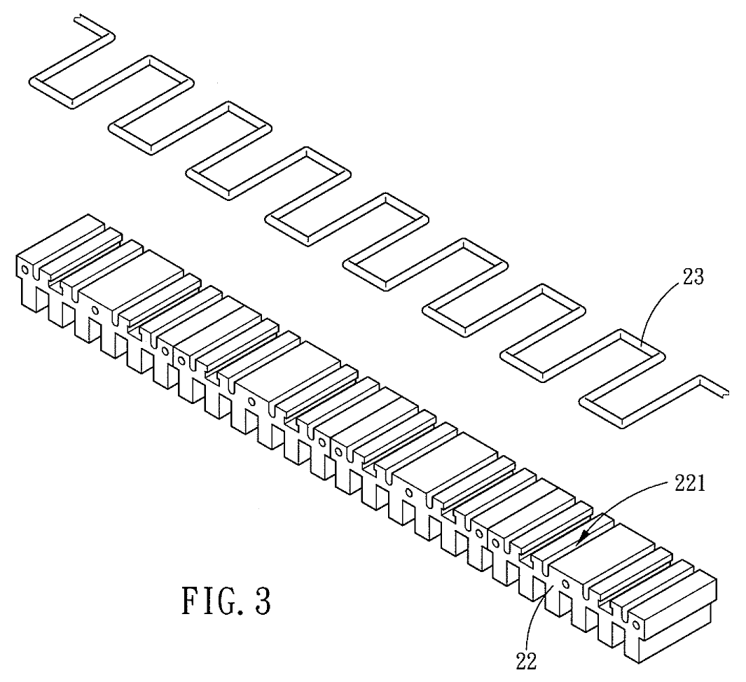

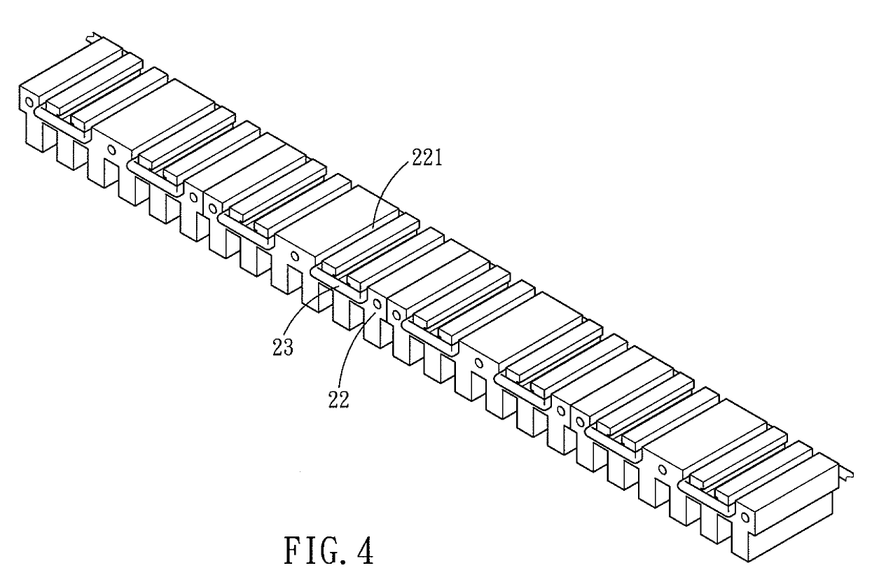

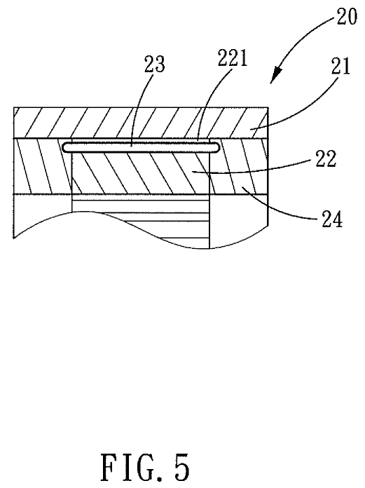

Referring to FIGS. 3-5, a liquid cooling type direct drive motor stator 20 in accordance with the present invention is mounted on a rotor shaft (not numbered) with magnets and comprises: an annular base 21, at least one silicon steel sheet 22, at least one metal cooling pipe 23, and a plurality of coils.

The annular base 21 is defined in the center thereof with a space 211 for accommodation of the shaft of the rotor.

The silicon steel sheet 22 is positioned on the inner surface of the space 211 of the annular base 21 and is wound around the rotor shaft. In the surface of the silicon steel sheet 22 is orderly formed a plurality of transverse grooves 221, and both ends of the respective transverse grooves 221 open toward outside.

The metal cooling pipe 23 is a metal heat radiating pipe continuously bent toward both sides (the metal material can be copper, and aluminum) and serves to enable the coolant to circulate therein. The aforementioned coolant supply system is of conventional technique, so further remarks will be omitted. The metal cooling pipe 23 is fixed on the inner surface of the space 211 of the annular base 21 along with the silicon steel sheet 22, and is positioned in the grooves 221 of the silicon steel sheet 22 section by section.

The coils 24 are wound around the silicon steel sheet 22.

For a better understanding of the present invention, reference should be made to the respective drawings again. The metal cooling pipe 23 is fixed on the inner surface of the space 211 of the annular base 21 along with the silicon steel sheet 22, and is positioned in the grooves 221 of the silicon steel sheet 22 section by section. Therefore, the coolant within the metal cooling pipe 23 can absorb the heat energy of the silicon steel sheet 22 quickly and directly, effectively reducing the heat transmission obstacles while improving the heat transmitting efficiency.

In addition to being compatible with the conventional water passage equipments, the metal cooling pipe 23 of the present invention can also be used in products independently. Therefore, when the present invention is used on the liquid cooling type direct drive motor stator 20 independently, it simplifies the conventional annular aluminum piece, the water passage system, and the circulation assembly on the annular base.

It is to be noted that the grooves of the silicon steel sheet of the present invention can be formed in the surface of the silicon steel sheet facing the annular base, and can also be formed in the opposite surface of the silicon steel sheet. Both designs can cool the silicon steel sheet directly.

While we have shown and described various embodiments in accordance with the present invention, it is clear to those skilled in the art that further embodiments may be made without departing from the scope of the present invention.

What is claimed is:

1. A stator for a liquid cooling type direct drive motor being mounted on a rotor shaft with magnets, and comprising: annular base, silicon steel sheet, at least one metal cooling pipe, and coils; wherein:
the annular base is centrally defined with a space for accommodation of the rotor shaft;
the silicon steel sheet is positioned in the annular base and annularly wound around the rotor shaft, in a surface of the silicon steel sheet is formed a plurality of grooves;
the metal cooling pipe is continuously bent toward both sides and is positioned in the grooves of the silicon steel sheet and serves to enable coolant to circulate therein; and
the coils are wound around the silicon steel sheet.

2. The stator for a liquid cooling type direct drive motor as claimed in claim 1, wherein the grooves of the silicon steel sheet are formed in a surface of the silicon steel sheet facing the annular base.

3. The stator for a liquid cooling type direct drive motor as claimed in claim 1, wherein the grooves of the silicon steel sheet are formed in another opposite surface of the silicon steel sheet.

4. The stator for a liquid cooling type direct drive motor as claimed in claim 2, wherein a plurality transverse through grooves is formed in the surface of the silicon steel sheet, and the metal cooling pipe is bent toward both sides and is engaged in the transverse grooves of the silicon steel sheet.

5. The stator for a liquid cooling type direct drive motor as claimed in claim 3, wherein a plurality transverse through grooves is formed in the surface of the silicon steel sheet, and the metal cooling pipe is bent toward left and right and is engaged in the transverse grooves of the silicon steel sheet.

6. The stator for a liquid cooling type direct drive motor as claimed in claim 1, wherein the metal cooling pipe is made of copper or aluminum.
